(19) United States
(12) Patent Application Publication
(10) Pub. No.: US 2007/0221115 A1
(43) Pub. Date: Sep. 27, 2007

(54) Sustainable wildlife deterrent method and apparatus

(76) Inventors: Getty D. Pollard, Park City, UT (US); John E. Pollard, Solvang, CA (US)

Correspondence Address: MARCUS G THEODORE, PC, 466 SOUTH 500 EAST, SALT LAKE CITY, UT, 84102, US

(21) Appl. No.: 11/386,169

(22) Filed: Mar. 21, 2006

(51) Int. Cl. A01M 29/00

(52) U.S. Cl. 116/22 A

(57) ABSTRACT

A lethal or non-lethal animal deterrent method and apparatus employing live predators in combination with three-dimensional predator figures to remove unwanted animals and birds from landfills, agricultural fields, airfields, and buildings to minimize animal and bird fruit and agricultural losses/damage and to prevent air strikes.

### BACKGROUND OF THE INVENTION

1. Field of Invention

The present invention relates to animal deterrent methods and apparatuses. Specifically, it relates to a lethal or non-lethal animal deterrent method and apparatus employing live predators in combination with three-dimensional predator figures to remove unwanted animals and birds from landfills, agricultural fields, airfields, and buildings to minimize animal and bird fruit and agricultural losses/damage and to prevent air strikes.

2. State of the Art

Various bird mitigation methods are known and employed near airports, agricultural fields, and other areas where unwanted animals congregate. These include falconry, pyrotechnics, shooting and other varied dispersal methods, to deter/scare birds. For example, Pueyo et al., U.S. Pat. No. 5,986,551 discloses a pesky bird and pest animal frightening device comprising rotating hunter or falcon silhouette periodically emitting a gunshot sound blast.

Asder, U.S. Pat. No. 3,735,514 discloses another bird frightening device employing a wind driven rotating cat silhouette.

Huffman and Peck, U.S. Pat. No. 1,167,502 discloses another rotating wind driven silhouette illustrated as a cat, which acts as a scarecrow. It may also include bells, which ring as the silhouette is moved.

Pass, U.S. Pat. No. 1,066,045 discloses a bird scaring device comprising a ground stake attached to the end of a wire having a helix or spiral at one end near the stake to allow the wire to bend and flex. At the other end of the wire is a strip of cloth, paper or the like, which moves in the wind to scare birds from strawberry and seed beds.

Watermann, U.S. Pat. No. 6,807,765 discloses a bird scaring device comprising a silhouette of a bird of prey having at least one hole there through such that the device is rotatably affixed to first and second lines such that the silhouette is moved by the wind. The device employs a third safety line in the event the silhouette becomes detached from the first and second line. It is used to scare away birds from a desired location, such as an airport, grape field or away from buildings.

Bachli, U.S. Pat. No. 4,109,605 discloses a Scarecrow System comprising a driven tow line carrying frightening devices such as optical or acoustical devices. The tow line is actuated by a drive assembly imparting a reciprocating moved to the main tow line by converting rotary drive motion into a linear back and forth motion.

Laidler, U.S. Pat. No. 6,742,471 discloses an Installation for Repelling Birds comprising a suspended dual endless cable driven by drive pulleys associated with an electric motor to which are affixed a plurality of bird scaring devices. The cables are then selectively activated by the motor to move the bird scaring devices such as strips of material, pennants, or reflecting materials.

Rousseau, Jr. et al., U.S. Pat. No. 4,131,079 discloses a wind rotated reflective scarecrow comprising a post suspended pair of large, thin, light weight, highly light reflective discs rotatably suspended from the remote end of a wire in cantilever fashion. As the wind interacts with the device, random, distracting motions as well as darting light reflections in a random erratic manner are generated on the area surrounding the post.

Pember, U.S. Pat. No. 4,074,653 discloses another Bird Frightener that comprises a pole that supports a plurality of arms rotatably positioned above a tree or bush. The arms include at least one streamer thereon that waives as the arm rotates. The arms are associated with cam means operable associated with the pole so that they move up and down in a sinusoidal movement as the arms rotate.

Sugimoto, U.S. Pat. No. 5,956,880 discloses a Bird Repellent Apparatus comprising a bird of prey figure attached to a guide rail via a self-propelled electric motor so that the bird of prey figure is moved there along. Said device also includes sound and light transmitters and sensors for detecting an incoming bird and a controller, which activates the motor such that the bird of prey figure is moved toward the incoming bird to scare it away. The device therefore is required to be located near an electric power source, or include a battery source for use in remote fields. The device is primarily used to prevent birds from roosting or excluding birds from entering buildings, hangers or warehouses and is limited to the radius of the guide rail. It does employ lethal raptorial birds for periodic frightening enforcement so the bird dispersal effects decline as the birds habituate to the bird of prey figures.

None of the references employ mechanical frightening devices alone or on tracks in conjunction with the use of live falcons or predator animals for periodic reinforcement. Their effectiveness therefore rapidly declines over time. The invention described below, provides a combination mechanical/live predator method and apparatus, which may be used in agricultural fields, buildings, or with landfills, sewage treatment and waste disposal ponds and any other airspace that needs protection from flocks of birds or other animals impacting its operations.

### OBJECTIVES OF THE INVENTION

The objectives of the sustainable wildlife deterrent method and apparatus are to provide a device that:

a. is used either as a non-lethal or a lethal device where required to provide more than a bird “scaring” device to address more aggressive nuisance feeding birds.

b. has predator effigies that are exact three-dimensional replicas of birds of prey and other four legged predators, down to feather color and feather pattern and are generally built to exact scale of live predators used to patrol the area

c. creates no noise or air emissions.

d. has no sensors, light detectors, infrared or light, or sounds generator augmentations, such as gunshots

e. is used in conjunction with live trained falcons and other patrolling predators to provide temporary bird or animal dispersal and control.

f. requires no cleaning or preparation of the site before starting services.

g. works 24 hours per day offering a nocturnal solution for animals.

h. can be used in the singular or multiple units per site and therefore does not require a minimum of two devices per site.

i. when used as a predator bird apparatus employs a target species that is used in conjunction with a predatory bird effigy to provide the effect of chasing or pursuing.

j. requires no individual drive motors with the predator effigies.

### SUMMARY OF THE INVENTION

The invention comprises a sustainable wildlife determent method and apparatus which can invoke lethal means and non-lethal means to reinforce protection/deterrent via employment with live predator animals. The method comprises locating a plurality of driven rotatable bases or track lines in an area from which unwanted animals are to be removed. These rotatable bases may be driven by a variety of motor sources, such as pneumatic, electric, water, and reciprocating engine power. However, only pneumatic, water, and electric motors are quiet enough for field applications. Electric motors require a power source in remote fields, and therefore batteries are generally employed for these operations. As batteries are heavy to haul around, and must be periodically recharged by taking them in to a central charging station, water or pneumatically driven motors are the most practical in the field. These require at least one air or water source associated with the driven bases or track lines to erratically turn or move them in the desired area If a water source is not available, a rechargeable compressed air tank is used for this purpose as they may be recharged in the field with portable air compressors. Water and compressed air drives are quiet, and don't emit air emissions.

A plurality of predator figures with movable appendages simulating lifelike movement is then attached to the rotatable bases or track lines usually with elastic cords of differing lengths such that as they move, the predator figures simulate a live predator. Preferably these are of three dimensions so that the appendages move through the air in a more natural manner. Periodically, the area from which unwanted animals are to be removed is patrolled with a live predator similar in size and shape to the predator figures for frightening enforcement so that the bird and animal dispersal effects do not decline as the pests habituate to the bird of prey figures.

The rotatable pneumatically driven rotatable bases are made with extenders or telescoping tubes of varying heights to be able to swing a raptorial figure in circles high in the air. The extenders have suspension ends at varying curves or angles from which the predator figures are suspended. These extenders elevate the raptor figures at different heights to simulate different flight paths. The extenders may be interchanged and periodically adjusted so that the raptorial figures are suspended at varying heights between 6 and 300 feet in the air. The driven bases are then activated intermittently to rotate the extenders to produce the erratic flight of the raptor when suspended from the suspension end with a bungee or stretchable elastic cord. In addition, the tail/wings are elastically hinged to move and flex when moved through the air. These fake raptor figures are preferably three dimensional exact replicas of real species unlike other devices, which do not imitate native North American Raptors.

The base rotational mechanism is positioned at the base of the unit, thereby avoiding a top heavy motor mounted on a support. The air ratchet mount at the bottom of the base rotational mechanism rotates the device so that the entire extender shaft and suspension ends move in circles, arcs, or elipses.

The pneumatically driven bases or track lines have a source of stored compressed air or pneumatic pump to provide compressed air, which causes pneumatic gears associated with the base to rotate or drive continuous track line to move suspended predator figures in abrupt life like movements. Emission type motors are therefore not generally employed. Naturally occurring wind to turn a pneumatic turbine, which turns gears, may supplement and also provide the energy to turn the bases in circular fashion. The tracks or bases can also be deployed and suspended via helium contained balloons support assists anchored at desired heights or positions.

The predator figures are three dimensional. The wings and tail of raptor predator figures move without the use of a motor. Instead, elastic hinges are employed at these joints to move and flex in the wind for more life-like simulation. When abruptly moved through the air, the wings and tail produce an attack motion similar to that of the live raptors used to periodically patrol the area.

Preferably, a second prey target is associated with the predator figures and positioned such that the predator figures move in a simulated chase of the second prey target as it moves. The target bird effigy is usually suspended from a second extender, which rotates in circles slightly ahead of the raptorial predator figure. This formation signals to the nuisance birds that this raptor is in pursuit of its target bird simulating a hunting hungry falcon—not just a raptor that is soaring with non-hunting flight movement in circles for no apparent reason as is the case with other bird scaring devices. Also, because the raptorial figure and target bird effigies are dangled from elastic cords having varying lengths, this generates the erratic flight behavior of an attacking raptor.

To enhance the effects of the sustainable wildlife deterrent method for birds, the device is used in association with the live raptors, which are trained to follow and obey in flight a mounted falcon trainer patrolling the area. Usually, ATV's and other motorized vehicles, and walking provide the means for moving the trainer around the fields. The protected locations have trained falcons following the vehicles in the air as they patrol the boundaries of the property. These live raptors usually have undergone Operant Conditioning to chase, wait-on, follow, perch, and dive on command, and are trained as both “imprints” and “non-imprints”. This requires them to be allowed to fly free for 1 sec up to 10 hours per day.

Where the sustainable wildlife deterrent method is to move unwanted grazing animals such as deer, from an area, the method and device are modified to employ four legged predator effigies. This comprises locating a plurality of rotatable pneumatically driven bases similar to those described above with shorter extenders approximately 6 feet off the ground in an area from which unwanted grazing animals are to be scared away. Instead of suspension ends, a drive pulley is attached to at least one end of the driven base extenders. A corresponding fixed or driven extender having a corresponding pulley end is then staked into the ground to form a travel boundary for the four legged predator. The pulley drive and pulley ends are then connected with a continuous drive line such that it is driven in response to the pneumatically or water driven pulley drive. At least one compressed air source is operably associated with the pneumatically driven bases to turn the driven bases in a manner to move the drive line in a desired direction.

At least one four legged predator figure with movable hinged appendages is then mounted to the drive line. This four legged predator has elastic hinged appendages which simulate lifelike walking or running movement, when moved by the drive line. Periodically the area from which unwanted animals to be removed is patrolled with a live four legged predator similar in size and shape to the four legged predator figures. Preferably, the four legged carnivores are shaped as lions, attack dogs, and/or other canine predators.

The foregoing sustainable wildlife deterrent method and apparatus thus provides a hybrid mechanical/live predator method to remove unwanted animals from a designated area.

### BRIEF DESCRIPTION OF THE DRAWINGS

FIG. 1 is a flow chart of the applicant's sustainable wildlife deterrent method.

FIG. 2 is a perspective view of a three dimensional predator raptor

FIG. 2a is an exploded view of a hinged wing.

FIG. 2b is an exploded view of a hinged tail.

FIG. 2c is an exploded view of a hinged leg.

FIG. 3 is a perspective view of a three dimensional four legged predator cat.

FIG. 4 illustrates a preferred deterrent mechanism embodiment.

FIG. 5 illustrated a bird deterrent specie prey target.

FIG. 6 illustrates a deer or ungulate deterrent specie prey target.

FIG. 7 illustrates a pig or boar deterrent specie prey target.

FIG. 8 illustrates a trainer patrolling with a live predator in conjunction with the mechanisms of FIG. 4.

FIG. 9 illustrates a typical placement of the mechanisms of FIG. 4.

FIG. 10 illustrates a preferred deterrent mechanism four legged predator embodiment.

### DESCRIPTION OF THE ILLUSTRATED EMBODIMENTS

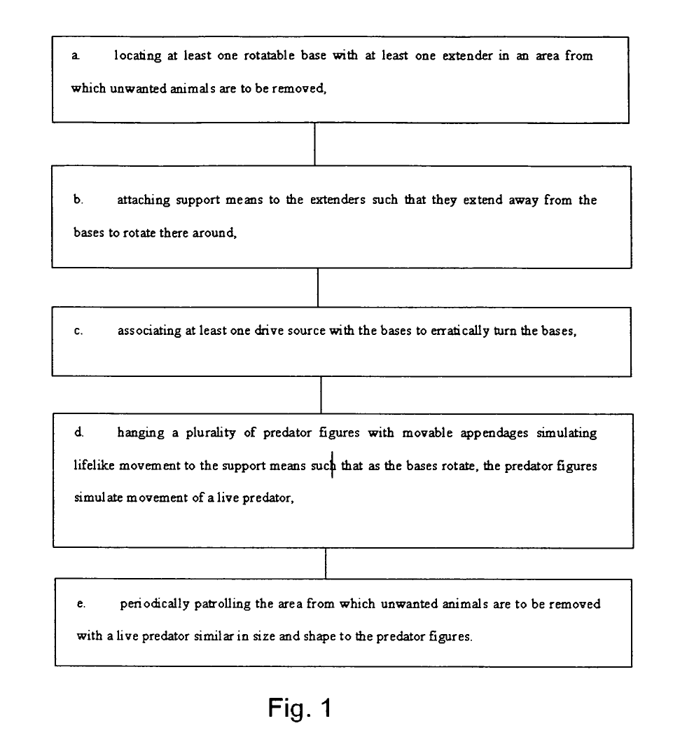

The invention relates to a hybrid/live predator sustainable wildlife deterrent method illustrated in FIG. 1. The method employs three dimensional predator effigies 10 discussed below.

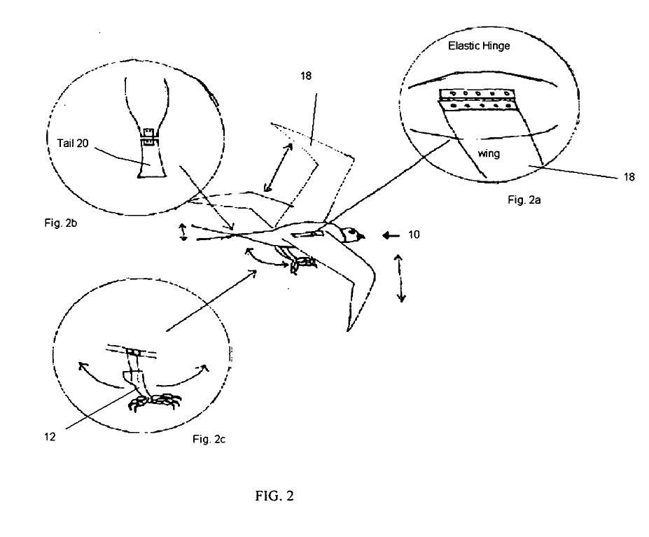

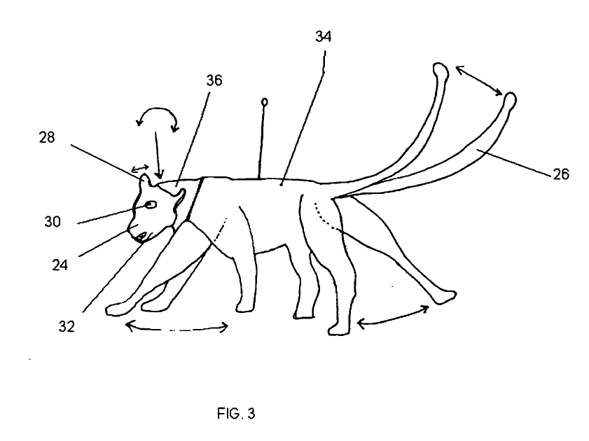

FIG. 2 illustrates a three dimensional predator raptor 10 with hinged bird legs 12 and talons 14, which provide for “real” simulated movement of forward and back, side to side. This is accomplished through elastic hinges 16 shown in the expanded views of the wing 18 attachment, FIG. 2a; the tail 20 attachment, FIG. 2b; and the foot 12 attachment, FIG. 2c. The expanded view FIG. 1b of the bird tail 20 attachment demonstrates how hinged appendage provides for rapid change in direction during flight. The arrows proximate each hinged appendage in FIGS. 2, 2a, 2b, and 2c demonstrate how the hinged wing 18, tail 20, and leg 12 appendages provide for rapid change in direction during flight due to speed of rotation and air forces as shown with the arrows near the raptor 10.

The raptor 10 is a three-dimensional model of the actual raptorial species patrolling the sector. Not only does this provide a look of more realism, but the air flow over the raptor 10 body affects a more life-like flight motion.

FIG. 3 illustrates a three-dimensional mountain lion predator 10 effigy with hinged legs 22, head 24, tail 26, ears 28, eyes 30, jaws 32, back 34, and neck 36 appendages. Arrows proximate the predator 10 effigy indicates the appendage movement of some of the appendages.

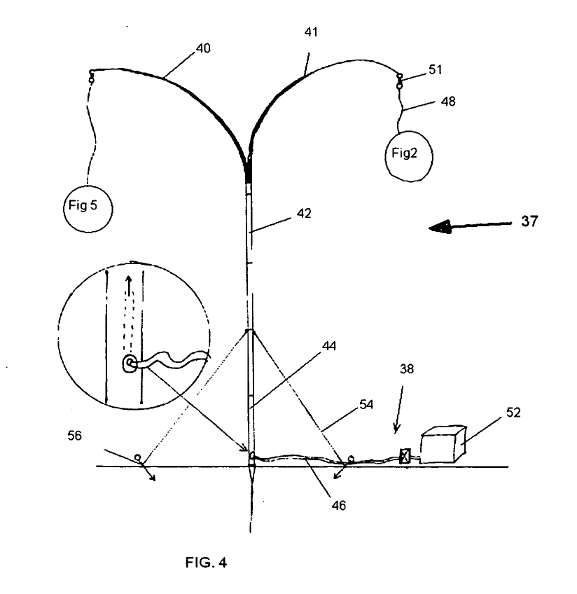

FIG. 4 illustrates the deterrent mechanism 37 driven by a pneumatic rotational mechanism 38, which moves the supports 40, 41 attached to a rotating extender 42 attached to a ground anchored center pole 44. An air hose 46 passes through the center pole 44 as shown and is connected to an air driven gear mechanism (not shown) associated with the rotating extender 42.

Suspended from the supports 40, 42 are elastic cords 48 from which the raptor 10 and prey target 50 are suspended. Usually swivels 51 are included to prevent tangling. Fixed length Bungee or flexible cords 48 allow for change in the flight path diameter based on random wind currents and speed of circular motion.

The supports 40, 41 are horizontal or curved to suspend the predator 10 and prey targets 50 away from the center pole. The supports 40, 41 may be flexible to create irregular paths or travel when turned in an erratic motion generate an irregular oval flight pattern with the raptor 10 behind or tracing the approximate path of the prey target 50, when powered by the compressed air or water, or portable air compressor 52. The pneumatic driven sustainable wildlife deterrent apparatus generally has guide wires 54 for anchoring tall structured units in the ground with ground anchors 56 to secure the center pole 44. Extension poles (not shown) are affixed to the rotating extender 42 for variable height adjustments from 4′ up to 400′. These are structured to allow the air hose 46 to travel up the center to connect to the air drive gear mechanism which pressure spins a gear providing rotation of the rotating extender 42 (similar to an air ratchet used with air driven power tools).

FIG. 5 illustrates a bird deterrent specie prey target 50.

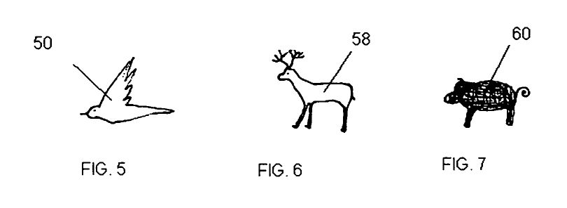

FIG. 6 illustrates a deer or ungulate deterrent specie prey target 58.

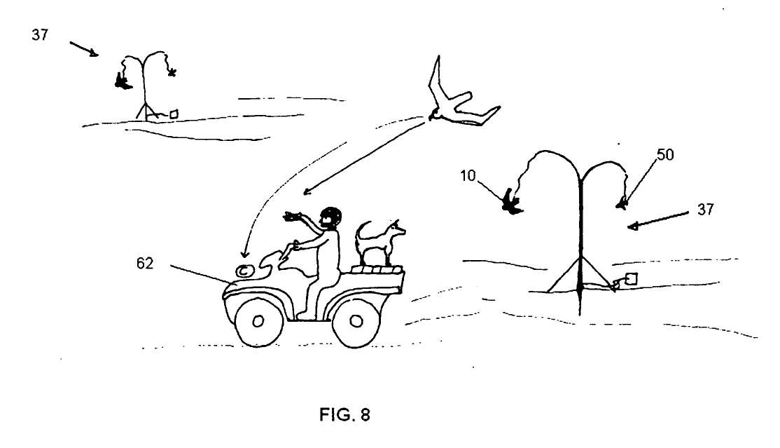

FIG. 7 illustrates a pig or boar deterrent specie prey target 60.

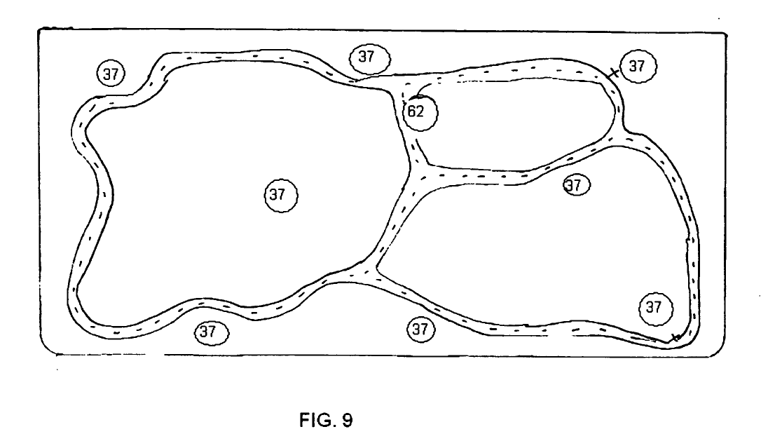

FIG. 8 illustrates a trainer driving an ATV or vehicle 62 (although other conveyances, such as jeeps, trucks, motorcycles, golf carts, bikes, horses, etc. may be used) through an area in which two raptor 10/prey target 50 deterrent mechanisms 37 are employed. The trainer has trained a single/multiple live birds of prey to follow as he/she moves across the given area that is being protected against unwanted/nuisance animals. The live trained bird of prey(s) checks in with the trainer periodically or with follows signals from the trainer. The bird of prey is then directed to carry out the desired deterrent effect. The human trainer can reward the bird of prey with food, lure, or other devices and have the bird of prey land on his/her helmet, glove, vehicle, ground, lure etc to receive a reward for doing a performed task.

Although a trained bird of prey and trained dog are illustrated, a trained lion or other trained predator may be used to provide a periodic enforcement deterrent against the target nuisance animals.

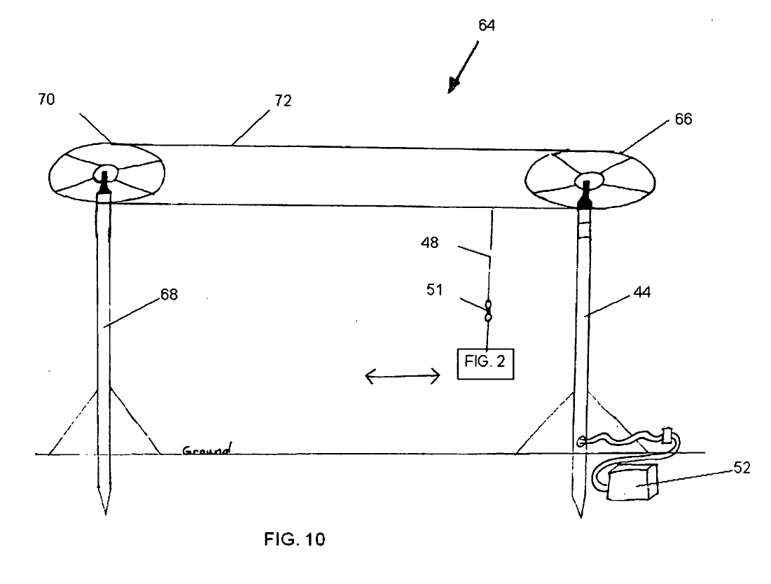

FIG. 9 illustrates a typical placement of raptor 10/prey target 50 deterrent mechanisms 37 are employed in areas patrolled by a trainer riding an ATV, motor vehicle, horse, golf cart, jeep, motorcycle, bicycle, scooter, etc. Single or multiple raptor 10/prey target 50 deterrent mechanisms 37 units are placed in strategic and random locations in the area in which unwanted nuisance animals and birds are to be kept out. The mobile trainer and live predator usually are not restricted to only roadways. The actual path patrolled is dependent upon the instincts of the live bird of prey or animal reinforcement, thereby preventing habituation.

FIG. 10 illustrates a deterrent mechanism 64 adapted to suspend and move a four legged predator figure with hinged appendages through an area from which unwanted grazing animals are to be scared away. A drive pulley 66 is attached to one end of the rotating driven base extenders 42 to rotate when driven by an air source 52 in a manner similar to that described above. It is also staked into the ground to anchor its center pole 44. At least one corresponding extender 68 is staked into the ground in an area from which unwanted grazing animals are to be scared away. This staked extender 68 has a corresponding pulley 70 rotatably attached to its end. A continuous drive line 72 is operably associated with the pulley drive such that it is driven by the drive pulley in an erratic motion. At least one four legged predator figure with movable hinged appendages, which simulate lifelike walking or running movement, when moved, such as that shown in FIG. 3, is attached to the drive line 72 via flexible cords 48. When activated, the four legged predator figure travels through the area from which unwanted animals are to be removed move as the track line moves.

This embodiment is used in conjunction with periodical patrols of the area with a live four legged predator similar in size and shape to the four legged predator figures, which is directed by a trainer in a manner similar to that described above.

The above method and apparatus provides a lethal or non-lethal animal deterrent method and apparatus employing live predators in combination with three-dimensional predator figures to remove unwanted animals and birds from landfills, agricultural fields, airfields, and buildings to minimize animal and bird fruit and agricultural losses/damage and to prevent air strikes. It is also used to areas to prevent nuisance animals from entering or occupying golf courses, agricultural fields, landfills, amusement parks, city parks, parking lots, stadiums, refineries, airfields, ships, docks, medical facilities, quarantined areas, beaches, restaurants, etc.

The above description and specification should not be construed as limiting the scope of the claims. The claims themselves contain the features deemed essential to the invention.

1. a sustainable wildlife deterrent method comprising:
a. locating at least one rotatable base with at least one extender in an area from which unwanted animals are to be removed,
b. attaching support means to at least one of the extenders such that they extend away from the bases to rotate there around,
c. associating at least one drive source with the bases to erratically turn the bases,
d. hanging a plurality of predator figures with movable appendages simulating lifelike movement to the support means such that as the bases rotate, the predator figures simulate movement of a live predator to frighten away unwanted animal prey,
e. periodically patrolling the area from which unwanted animal prey are to be removed with a live predator similar in size and shape to the predator figures.

2. A sustainable wildlife deterrent method according to claim 1, wherein the drive source comprises a pneumatic drive system operable associated with the rotatable bases and the drive source comprises at least one compressed air source associated with the pneumatically driven bases to turn the bases.

3. A sustainable wildlife deterrent method according to claim 2, wherein the pneumatic drive system includes a gearing system associated with the compressed air source, which drives gears associated with the base to rotate such that at least on of the extenders and suspended predator figures moves in abrupt movements.

4. A sustainable wildlife deterrent method according to claim 1, wherein the predator figures are three dimensional raptors with hinged wings and tail simulating flight, when moved through the airs and wherein the live predator is one or more live raptors.

5. A sustainable wildlife deterrent method according to claim 4, wherein at least one of the extenders are of different heights or extendable to elevate the raptors at different heights to simulate different flight paths.

6. A sustainable wildlife deterrent method according to claim 5, wherein a prey target is attached to at least one second extender associated with the rotating base such that the predator figures are positioned such that the predator figures move in a simulated chase of the prey target as both move.

7. A sustainable wildlife deterrent method according to claim 4, wherein the live raptors are trained to follow in flight a mounted trainer patrolling the area.

8. A sustainable wildlife deterrent method according to claim 7, wherein the live raptors have undergone operant conditioning or other training to chase, wait-on, follow, perch, and dive on command.

9. A sustainable wildlife deterrent method according to claim 8, wherein the live raptors are trained as both “imprints” and “non-imprints” and are allowed to fly free for 1 sec up to 10 hours per day.

10. A sustainable wildlife deterrent method according to claim 1, wherein the support means comprises:
a. a drive pulley attached to at least one end of the driven base extenders,
b. at least one corresponding extender staked into the ground in an area from which unwanted grazing animals are to be scared away,
c. a continuous drive line associated with the pulley drive such that it is driven by the drive pulley in an erratic motion,
d. mounting at least one four legged predator figure with movable hinged appendages to the drive line to simulate lifelike walking or running movement as the mounted predator figure is moved by the drive line and travels through the area from which unwanted animal prey are to be removed move,
e. periodically patrolling the area from which unwanted animal prey are to be removed with a live four legged predator similar in size and shape to the four legged predator figures.

11. A sustainable wildlife deterrent method according to claim 10, wherein the drive source comprises a pneumatic drive system operable associated with the rotatable bases and the drive source comprises at least one compressed air source associated with the pneumatically driven bases to turn the bases.

12. A sustainable wildlife deterrent method according to claim 11, wherein the pneumatic drive system includes a gearing system associated with the compressed air source, which drives gears associated with the base to rotate such that at least one of the extenders and suspended predator figures moves-in abrupt movements.

13. A sustainable wildlife deterrent method according to claim 10, wherein the predator figures are three dimensional four legged carnivores with hinged legs simulating running, when moved along the ground.

14. A sustainable wildlife deterrent method according to claim 13, wherein four legged carnivores are shaped as lions, attack dogs, and/or other canine predators.

15. A sustainable wildlife deterrent apparatus comprising:
a. a plurality of rotatable pneumatically driven bases adapted to be placed in an area from which unwanted animal prey are to be removed,
b. at least one extenders with a drive pulley attached to at least one end of the driven bases,
c. at least one corresponding extender with corresponding pulley staked into the ground in an area from which unwanted grazing animals are to be scared away,
d. a continuous drive line associated with the pulleys and pulley drive such that it is driven by the drive pulley in an erratic motion,
e. at least one air source associated with the pneumatically driven bases to turn the bases, and
f. a plurality of predator figures in the similar size and shape of a live predator patrolling the area with movable appendages simulating lifelike movement affixed to at least one of the extenders attached to the rotatable bases such that as they rotate, the predator figures simulate the live predator.

16. A sustainable wildlife deterrent apparatus according to claim 15, wherein the pneumatically driven bases include a gearing system associated with the source of stored compressed air, which drives gears associated with the base to rotate such that the predator figure moves in abrupt movements.

17. A sustainable wildlife deterrent apparatus comprising:
a. a plurality of rotatable pneumatically driven bases located in an area from which unwanted prey birds are to be removed,
b. extenders with suspension ends attached to the bases such that the suspension ends extend away from the extender,
c. at least one compressed air source associated with the pneumatically driven bases to turn the bases,
d. a plurality of predator raptor figures in similar size and shape of a live raptor patrolling the area with movable appendages simulating lifelike movement affixed to the suspension ends of the extenders attached to the rotatable bases such that as they rotate, the predator raptor figures simulate the motion of the live raptors.

18. A sustainable wildlife deterrent apparatus according to claim 17, wherein the predator raptor figures are three dimensional with hinged wings and tail simulating flight, when moved through the air.

19. A sustainable wildlife deterrent apparatus according to claim 17, wherein the extenders are adjustable to elevate the predator raptor figures at different heights to simulate different flight paths.

20. A sustainable wildlife deterrent apparatus according to claim 17, wherein a prey target is attached to a second extender associated with the rotating base such that the predator figures are positioned relative to the prey target and move in a simulated chase of the prey target as both move.

21. A sustainable wildlife deterrent apparatus according to claim 17, including transport means to transport a mounted trainer with a live raptor patrolling the area so that trained live raptors will follow and respond to the trainers commands to chase, wait-on, follow, perch, and dive.
